(19) United States
(12) Patent Application Publication
(10) Pub. No.: US 2024/0225960 A9
(43) Pub. Date: Jul. 11, 2024

(54) Infant Bottle Holding Device

(71) Applicant: Derry-Ann Morgan, Port St. Lucie, FL (US)

(72) Inventor: Derry-Ann Morgan, Port St. Lucie, FL (US)

(21) Appl. No.: 18/317,206

(22) Filed: May 15, 2023

Related U.S. Application Data
(60) Provisional application No. 63/418,745, filed on Oct. 24, 2022.

(51) Int. Cl. A61J 9/06

(52) U.S. Cl. CPC A61J 9/0669; A61J 9/0638; A61J 2205/30

(57) ABSTRACT

The present invention relates to an infant bottle-holding device for hands-free bottle feeding. The device is primarily comprised of a curved member with at least one arm having at least one appendage that holds a bottle. The curved member can be placed around the waist area of an infant and is secured to said area via compressive force. The arm is repositionable and extends from the curved member, wherein the arm has a bottle-holding member with the appendage that secures the bottle within the member via compressive force such that it cannot be removed by an infant during feeding.

### CROSS-REFERENCE TO RELATED APPLICATION

The present application claims priority to, and the benefit of, U.S. Provisional Application No. 63/418,745, which was filed on Oct. 24, 2022, and is incorporated herein by reference in its entirety.

### FIELD OF THE INVENTION

The present invention relates generally to the field of bottle-feeding devices. More specifically, the present invention relates to an infant bottle-holding device primarily comprised of a curved member with at least one arm having at least one appendage that holds a bottle. The curved member can be placed around the waist area of an infant and is secured to said area via compressive force. The arm is repositionable and extends from the curved member, wherein the arm has a bottle-holding member with the appendage that secures the bottle within the member via compressive force such that it cannot be removed by an infant during feeding. Accordingly, the present disclosure makes specific reference thereto. Nonetheless, it is to be appreciated that aspects of the present invention are also equally applicable to other like applications, devices, and methods of manufacture.

### BACKGROUND

When bottle feeding an infant, a parent or caregiver often holds the infant in one arm while supporting the bottle the infant is feeding from with the other arm. As a result, the parent or caregiver's hands are full and occupied for the entire feeding time. This prevents them from doing anything else, which is undesirable.

Therefore, there exists a long-felt need in the art for an infant feeding device. More specifically, there exists a long-felt need in the art for an infant bottle-holding device. There also exists a long-felt need in the art for an infant bottle-holding device that allows a user to feed an infant in a hands-free manner. Further, there exists a long-felt need in the art for an infant bottle-holding device that allows a user to feed an infant in a hands-free manner, and wherein the device optimally positions the bottle during feeding.

The subject matter disclosed and claimed herein, in one embodiment thereof, comprises an infant bottle-holding device. The device is primarily comprised of a curved member with at least one arm having at least one appendage that holds a bottle. The curved member can be placed around the waist area of an infant and is secured to said area via compressive force. The arm extends from the curved member, wherein the arm has a bottle-holding member. The appendage of the bottle-holding member secures the bottle within the member via compressive force such that it cannot be removed by an infant during feeding. The arm is repositionable such that the bottle can be optimally placed in proximity to the infant for feeding.

In this manner, the infant bottle-holding device of the present invention accomplishes all the foregoing objectives and provides an infant bottle-holding device that allows a user to feed an infant in a hands-free manner. Further, the device optimally positions the bottle during feeding. In addition, the appendages prevent the bottle from being removed from the bottle-holding member by an infant during use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an infant bottle-holding device primarily comprised of a curved member with at least one arm having at least one appendage that holds a bottle. The curved member of the device can be placed around the waist area of an infant to secure the device to the infant. The curved member is preferably flexible such that it creates a compressive force against the waist area of the infant such that the curved member is retained around the waist area. The inner surface of the curved member may be comprised of at least one padding that provides a barrier between the curved member and the waist area of the infant for comfort.

The outer surface of the curved member is comprised of at least one arm that is preferably flexible and can be bent to any desired position. In another embodiment, the arm is rigid and can be repositioned using at least one pivot point that connects the arm to the outer surface. The pivot point may be any type of joint or connection that allows the arm to rotate 360 degrees around the point.

The arm is also comprised of at least one bottle-holding member that generally resembles a hand in shape and has at least one flexible appendage that resembles a finger. At least one bottle can be placed within the member and retained within the member via the appendages which provide a compressive force against the bottle. Further, the compressive force prevents the infant from removing the bottle.

The device is also comprised of a method of using the device, wherein the curved member is first placed around the waist area of an infant. Then, a bottle is placed within the bottle-holding member. The bottle is secured within the member via at least one appendage. Next, the arm can be repositioned such that the infant can easily feed from the bottle.

Accordingly, the infant bottle-holding device of the present invention is particularly advantageous as it provides an infant bottle-holding device that allows a user to feed an infant in a hands-free manner. Further, the device optimally positions the bottle during feeding. In addition, the appendages prevent the bottle from being removed from the bottle holding member by an infant during use. In this manner, the infant bottle-holding device overcomes the limitations of existing infant bottle-feeding methods.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an infant bottle-holding device of the present invention in accordance with the disclosed architecture;

FIG. 2 illustrates a perspective view of one potential embodiment of an infant bottle-holding device of the present invention while holding a bottle in accordance with the disclosed architecture;

FIG. 3 illustrates a perspective view of one potential embodiment of an infant bottle-holding device of the present invention while attached to an infant and while holding a bottle in accordance with the disclosed architecture; and

FIG. 4 illustrates a flowchart of a method of using one potential embodiment of an infant bottle-holding device of the present invention while holding a bottle in accordance with the disclosed architecture.

### DETAILED DESCRIPTION

The innovation is now described with reference to the drawings, wherein like reference numerals are used to refer to like elements throughout. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an infant feeding device. More specifically, there exists a long-felt need in the art for an infant bottle-holding device. There also exists a long-felt need in the art for an infant bottle-holding device that allows a user to feed an infant in a hands-free manner. Further, there exists a long-felt need in the art for an infant bottle-holding device that allows a user to feed an infant in a hands-free manner, and wherein the device optimally positions the bottle during feeding.

The present invention, in one exemplary embodiment, is comprised of an infant bottle-holding device. The device is primarily comprised of a curved member with at least one arm having at least one appendage that holds a bottle, wherein the curved member of the device can be placed around the waist area of an infant in order to secure the device to the infant. The curved member is preferably flexible such that it creates a compressive force against the waist area of the infant such that the curved member is retained around the waist area. The inner surface of the curved member may be comprised of at least one padding that provides a barrier between the curved member and the waist area of the infant for comfort.

The outer surface of the curved member is comprised of at least one arm. The arm is preferably flexible, and as a result can be bent to any desired position. In a different embodiment, the arm is rigid and can be repositioned using at least one pivot point that connects the arm to the outer surface. The pivot point may be any type of joint or connection that allows the arm to rotate 360 degrees around the point.

The arm is also comprised of at least one bottle-holding member. The member generally resembles a hand in shape and has at least one flexible appendage that resembles a finger. At least one bottle can be placed within the member and retained within the member via the appendages which provide a compressive force against the bottle. Further, the compressive force prevents the infant from removing the bottle.

The device is also comprised of a method of using the device. First, the curved member is placed around the waist area of an infant. Then, a bottle is placed within the bottle-holding member. The bottle is secured within the member via at least one appendage. Next, the arm can be repositioned such that the infant can easily feed from the bottle.

Accordingly, the infant bottle-holding device of the present invention is particularly advantageous as it provides an infant bottle-holding device that allows a user to feed an infant in a hands-free manner. Further, the device optimally positions the bottle during feeding. In addition, the appendages prevent the bottle from being removed from the bottle-holding member by an infant during use. In this manner, the infant bottle-holding device overcomes the limitations of existing infant bottle-feeding methods.

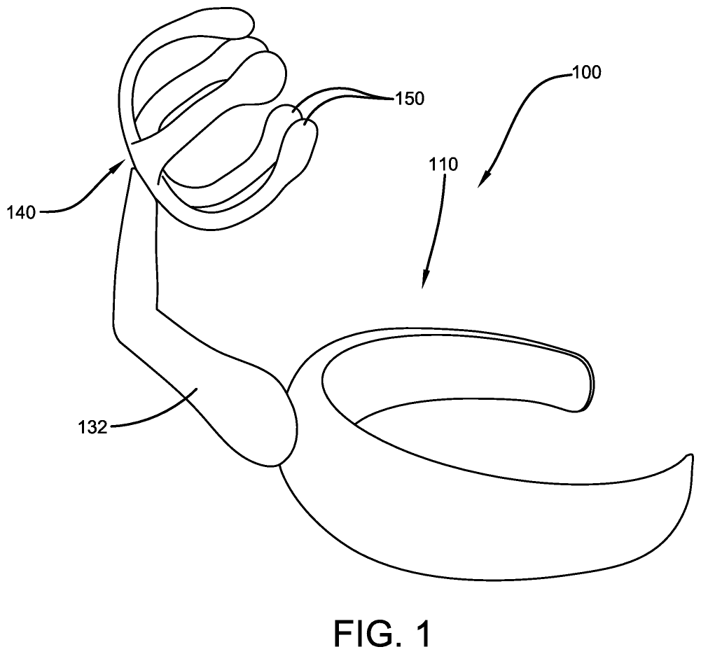

Referring initially to the drawings, FIG. 1 illustrates a perspective view of one potential embodiment of an infant bottle-holding device 100 of the present invention in accordance with the disclosed architecture. The device 100 is primarily comprised of a curved member 110 with at least one arm 132 having at least one appendage 150 that holds a bottle 10. The device 100 is preferably comprised of a flexible plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The plastic material is preferably washable/dishwasher safe for ease of cleaning. The device 100 may be any color known in the art and may be comprised of at least one indicia 160 in the form of an image, a pattern, a symbol, a word, etc.

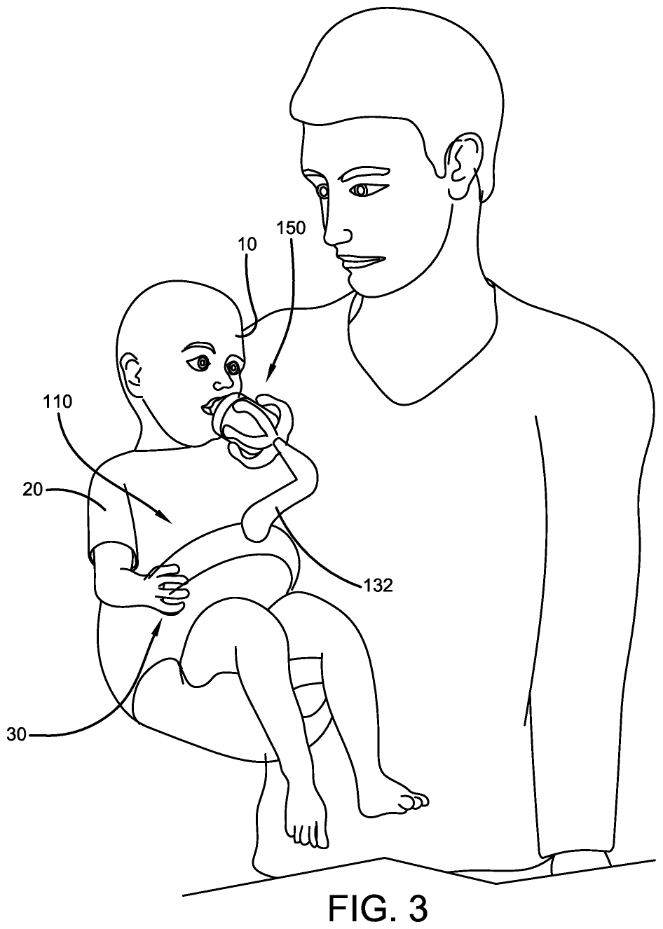

The curved member 110 of the device 100 can be placed around the waist area 30 of an infant 20 in order to secure the device 100 to the infant, as seen in FIG. 3. The curved member 110 is preferably flexible such that it creates a compressive force against the waist area 30 of the infant 20 such that the curved member 110 is retained around the waist area 30.

In one embodiment, the inner surface 120 of the curved member 110 is comprised of at least one padding 122. The padding 122 may be any type of foam, gel, plush padding, etc., known in the art. The padding 122 provides a barrier between the curved member 110 and waist area 30 of the infant 20 for comfort. In one embodiment, the padding 122 may cover the entire device 100.

The outer surface 130 of the curved member 110 is comprised of at least one arm 132. In the preferred embodiment, the arm 132 is flexible and can be bent to any desired position. In another embodiment, the arm 132 is rigid and can be repositioned using at least one pivot point 134 that connects the arm 132 to the outer surface 130. The pivot point 134 may be any type of joint or connection that allows the arm 132 to rotate 360 degrees around the point 134. The point 134 is preferably a ball joint.

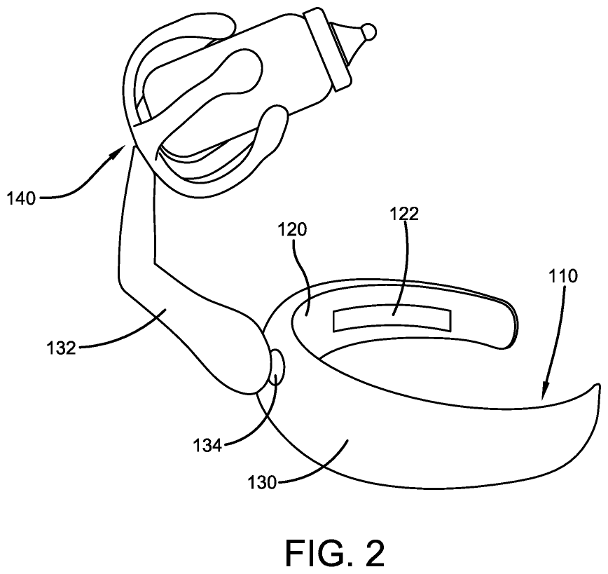

The arm 132 is also comprised of at least one bottle-holding member 140. The member 140 generally resembles a hand in shape and has at least one flexible appendage 150 that resembles a finger. At least one bottle 10 can be placed within the member 140 and retained within the member 140 via the appendages 150 which provide a compressive force against the bottle 10, as seen in FIG. 2. Further, the compressive force prevents the infant 20 from removing the bottle 10. In this manner, the device 100 offers a hands-free bottle feeding experience for the infant 20 and adult.

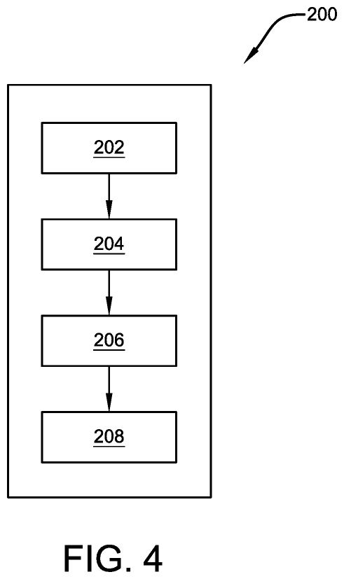

FIG. 4 illustrates a flowchart of a method of using 200 one potential embodiment of an infant bottle-holding device 100 of the present invention while holding a bottle in accordance with the disclosed architecture. The device 100 is also comprised of a method of using 200 the device 100. First, the curved member 110 of the device 100 is placed around the waist area 30 of an infant 20 [Step 202]. Then, a bottle 10 is placed within the bottle holding member 140, wherein the bottle 10 is secured within the member 140 via at least one appendage 150 [Step 204]. Next, the arm 132 can be repositioned such that the infant 10 can easily feed from the bottle 10 [Step 206]. Once the infant 10 has finished feeding from the bottle 10, the bottle can be removed from the member 140 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “infant bottle-holding device” and “device” are interchangeable and refer to the infant bottle-holding device 100 of the present invention.

Notwithstanding the foregoing, the infant bottle-holding device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the infant bottle-holding device 100 as shown in the FIGS. are for illustrative purposes only, and that many other sizes and shapes of the infant bottle-holding device 100 are well within the scope of the present disclosure. Although the dimensions of the infant bottle-holding device 100 are important design parameters for user convenience, the infant bottle-holding device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An infant bottle-holding device comprising:
a curved member;
an arm attached to the curved member; and
a bottle-holding member comprised of an appendage.

2. The infant bottle-holding device of claim 1, wherein the arm is comprised of a flexible arm.

3. The infant bottle-holding device of claim 1, wherein the curved member is comprised of a padding.

4. The infant bottle-holding device of claim 1, wherein the appendage is a flexible appendage.

5. The infant bottle-holding device of claim 1, wherein the appendage is comprised of a finger-like shape.

6. The infant bottle-holding device of claim 1, wherein the bottle-holding member is comprised of a hand-like shape.

7. The infant bottle-holding device of claim 1, wherein the curved member is comprised of a flexible material.

8. The infant bottle-holding device of claim 7, wherein the flexible material is comprised of a dishwasher-safe plastic.

9. The infant bottle-holding device of claim 1 further comprised of an indicia.

10. An infant bottle-holding device comprising:
a curved member;
an arm attached to the curved member via a pivot point; and
a bottle-holding member comprised of an appendage.

11. The infant bottle-holding device of claim 10, wherein the pivot point is comprised of a ball joint.

12. The infant bottle-holding device of claim 10, wherein the arm can rotate 360 degrees around the pivot point.

13. The infant bottle-holding device of claim 10, wherein an inner surface of the curved member is comprised of a padding.

14. The infant bottle-holding device of claim 13, wherein the padding is comprised of a gel, a foam, or a flush padding.

15. The infant bottle-holding device of claim 10, wherein the curved member is comprised of a flexible material.

16. The infant bottle-holding device of claim 15, wherein the flexible material is comprised of a dishwasher-safe plastic.

17. The infant bottle-holding device of claim 10 further comprised of an indicia.

18. A method of using an infant bottle-holding device, the method comprising the steps of:
placing a curved member of an infant bottle-holding device around a waist area of an infant;
placing a bottle in a bottle-holding member of the infant bottle-holding device; and
positioning an arm of the infant bottle-holding device such that the infant can feed from the bottle.

19. The method of claim 18 further comprised of a step of removing the bottle from the bottle-holding member when the infant has finished feeding from the bottle.

20. The method of claim 18, wherein the curved member is secured around the waist area via a compressive force.
